(19) United States
(12) Patent Application Publication
(10) Pub. No.: US 2022/0195103 A1
(43) Pub. Date: Jun. 23, 2022

(54) POLYMER, CURABLE COMPOSITION, AND CURED SUBSTANCE

(71) Applicant: FUJIFILM Corporation, Tokyo (JP)

(72) Inventors: Hirohisa HOKAZONO, Kanagawa (JP); Toshihide YOSHITANI, Kanagawa (JP)

(73) Assignee: FUJIFILM Corporation, Tokyo (JP)

(21) Appl. No.: 17/691,059

(22) Filed: Mar. 9, 2022

Related U.S. Application Data
(63) Continuation of application No. PCT/JP2020/033913, filed on Sep. 8, 2020.

(30) Foreign Application Priority Data
Sep. 27, 2019 (JP) 2019-176625

(51) Int. Cl. C08F 299/04

(52) U.S. Cl. CPC C08F 299/0492

(57) ABSTRACT

The present invention provides a polymer capable of forming a cured substance showing high adhesiveness with respect to a wet adherend, a curable composition, and a cured substance. The polymer according to an embodiment of the present invention has a repeating unit represented by Formula (1).

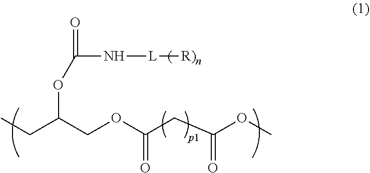

R represents an acryloyloxy group, a methacryloyloxy group, an acrylamide group, or a methacrylamide group. L represents an (n+1)-valent linking group. n represents an integer of 1 or more. p1 represents an integer of 1 or more.

### CROSS-REFERENCE TO RELATED APPLICATIONS

This application is a Continuation of PCT International Application No. PCT/JP2020/033913 filed on Sep. 8, 2020, which claims priority under 35 U.S.C. § 119(a) to Japanese Patent Application No. 2019-176625 filed on Sep. 27, 2019. The above applications is hereby expressly incorporated by reference, in its entirety, into the present application.

### BACKGROUND OF THE INVENTION

### 1. Field of the Invention

The present invention relates to a polymer, a curable composition, and a cured substance.

### 2. Description of the Related Art

In recent years, biodegradable materials have been attracting attention and are expected to be applied to medical adhesives and the like. In the present specification, “biodegradable” includes the property of decomposing in a living body, the property of dissolving in a living body, and the property of being absorbed into a living body.

Examples of the biodegradable materials include a polymer formed of glycerol and a divalent carboxylic acid such as sebacic acid (for example, polyglycerol sebacate).

Especially, JP2018-521203A discloses a prepolymer prepared by introducing a polymerizable group into the aforementioned polymer via an ester group. According to this document, the prepolymer is applicable to adhesives and the like.

### SUMMARY OF THE INVENTION

Incidentally, in order for a polymer to be applied to an adhesive used in a living body, such as a medical adhesive, the polymer needs to have high adhesiveness. Particularly, considering the use in a living body, the polymer needs to exhibit high adhesiveness to a wet adherend.

As a result of studying the adhesiveness with respect to a wet adherend by using a composition containing the prepolymer described in JP2018-521203A, the inventors of the present invention have found that the adhesiveness has not reached the currently required level and needs to be further improved.

The present invention has been made in consideration of the above circumstances, and an object thereof is to provide a polymer capable of forming a cured substance showing high adhesiveness with respect to a wet adherend.

Another object of the present invention is to provide a curable composition containing the aforementioned polymer and a cured substance.

As a result of performing intensive studies, the inventors of the present invention have found that the objects can be achieved by the following constitution.

(1) A polymer having a repeating unit represented by Formula (1) which will be described later.

(2) The polymer described in (1), in which R represents an acryloyloxy group.

(3) The polymer described in (1) or (2), in which n is 1 or 2.

(4) The polymer described in any one of (1) to (3), in which p1 is an integer of 4 to 10.

(5) A curable composition containing the polymer described in any one of (1) to (4).

(6) The curable composition described in (5), further containing a polymerization initiator.

(7) A cured substance formed of the curable composition described in (5) or (6).

According to an aspect of the present invention, it is possible to provide a polymer capable of forming a cured substance showing high adhesiveness with respect to a wet adherend.

Furthermore, according to another aspect of the present invention, it is possible to provide a curable composition containing the aforementioned polymer and a cured substance.

### DESCRIPTION OF THE PREFERRED EMBODIMENTS

Hereinafter, the present invention will be specifically described. In the present specification, a range of numerical values described using “to” means a range including numerical values listed before and after “to” as a lower limit and an upper limit. First, the terms used in the present specification will be described.

One of the feature points of the polymer according to an embodiment of the present invention is that a polymerizable group such as an acryloyloxy group is introduced into the polymer via a urethane bond.

The reason why the use of the polymer according to the embodiment of the present invention makes it possible to obtain a cured substance having high adhesiveness is unclear, but is assumed to be as below, for example. Presumably, a wet adherend and the urethane bond may have an interaction, which may improve the adhesiveness; the urethane bonds in the polymer may have an interaction and improve the hardness of the cured substance, which may consequently lead to the improvement of adhesiveness; and the urethane bonds may have an interaction, which may make it easy for the polymerizable groups to be adjacent to each other and improve crosslink density.

Hereinafter, the polymer, the curable composition, and the cured substance according to an embodiment of the present invention will be specifically described.

<Polymer>

(Repeating Unit Represented by Formula (1))

The polymer according to an embodiment of the present invention has a repeating unit represented by Formula (1).

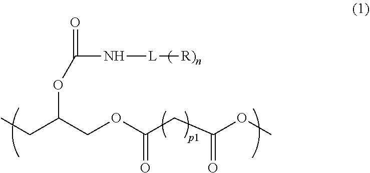

R represents an acryloyloxy group (CH₂═CH—COO—), a methacryloyloxy group (CH₂═C(CH₃)—COO—), an acrylamide group (CH₂═CH—CONH—), or a methacrylamide group (CH₂═C(CH₃)—CONH—). Among these, in view of further improving the adhesiveness of a cured substance (hereinafter, also simply described as “in view of further improving the effects of the present invention”), an acryloyloxy group or a methacryloyloxy group is preferable, and an acryloyloxy group is more preferable.

L represents an (n+1)-valent linking group. For example, in a case where n is 1, L represents a divalent linking group, and in a case where n is 2, L represents a trivalent linking group.

Examples of the divalent linking group include a divalent hydrocarbon group which may have a substituent (for example, a divalent aliphatic hydrocarbon group such as an alkylene group having 1 to 10 (preferably 1 to 5) carbon atoms, an alkenylene group having 1 to 10 carbon atoms, and an alkynylene group having 1 to 10 carbon atoms, and a divalent aromatic hydrocarbon group such as an arylene group), a divalent heterocyclic group, —O—, —S—, —N(Q)-, —CO—, and a group as a combination of these (for example, —O—CO—, —O-divalent hydrocarbon group-, -divalent hydrocarbon group-O-divalent hydrocarbon group-, —(O-divalent hydrocarbon group)_{q}-O— (q represents an integer of 1 or more), -divalent hydrocarbon group —O—CO—, and the like). Q represents a hydrogen atom or a substituent. The type of substituent is not particularly limited, and examples thereof include a hydrocarbon group such as an alkyl group and an aryl group.

Especially, examples of the divalent linking group include an alkylene group, —O—, —S—, —N(Q)-, —CO—, or a group as a combination of these (for example, —O-divalent hydrocarbon group-, and -divalent hydrocarbon group-O-divalent hydrocarbon group-).

The alkylene group may be linear, branched, or cyclic.

The number of carbon atoms in the alkylene group is not particularly limited, and is preferably 1 to 10, more preferably 1 to 5, and even more preferably 1 to 3.

Examples of the trivalent linking group include a nitrogen atom (—N<) and a group represented by Formula (X). In Formula (X), * represents a binding position.

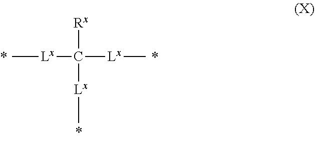

R^{x} represents a hydrogen atom or a substituent. The type of substituent is not particularly limited, and examples thereof include a hydrocarbon group such as an alkyl group and an aryl group.

L^{x} each independently represents a single bond or a divalent linking group. The definition of the divalent linking group is as described above.

m represents an integer of 1 or more. The upper limit of n is not particularly limited. In many cases, n is an integer of 10 or less. In view of further improving the effects of the present invention, n is preferably an integer of 1 to 5, and more preferably 1 or 2.

p1 represents an integer of 1 or more. The upper limit of p1 is not particularly limited. In many cases, p1 is an integer of 25 or less. In view of further improving the effects of the present invention, p1 is preferably an integer of 2 to 20, more preferably an integer of 4 to 10, even more preferably an integer of 4 to 8, and particularly preferably 8.

The content of the repeating unit represented by Formula (1) in the polymer is not particularly limited. In view of further improving the effects of the present invention, the content of the repeating unit represented by Formula (1) with respect to the total content of repeating units in the polymer is preferably 10 to 80 mol %, and more preferably 20 to 60 mol %.

(Other Repeating Units)

The polymer according to the present invention may have a repeating unit other than the repeating unit represented by Formula (1).

For example, the polymer may have a repeating unit represented by Formula (2).

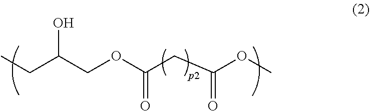

p2 represents an integer of 1 or more. The upper limit of p² is not particularly limited. In many cases, p2 is an integer of 25 or less. In view of further improving the effects of the present invention, p2 is preferably an integer of 2 to 20, more preferably an integer of 4 to 10, even more preferably an integer of 4 to 8, and particularly preferably 8.

The content of the repeating unit represented by Formula (2) in the polymer is not particularly limited. In view of further improving the effects of the present invention, the content of the repeating unit represented by Formula (2) with respect to the total content of repeating units in the polymer is preferably 20 to 90 mol %, and more preferably 25 to 70 mol %.

The total content of the repeating unit represented by Formula (1) and the repeating unit represented by Formula (2) in the polymer is not particularly limited. In view of further improving the effects of the present invention, the total content of these repeating units with respect to the total content of repeating units in the polymer is preferably 60 mol % or more, and more preferably 70 mol % or more. The upper limit of the total content of the repeating units represented by Formulas (1) and (2) is not particularly limited, and may be 100 mol %, for example.

The polymer may have a crosslinking structure. That is, the polymer may be a branched polymer.

For example, the polymer may have a repeating unit represented by Formula (3).

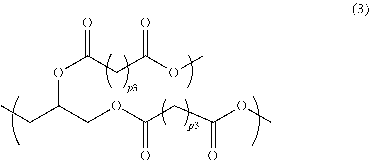

p3 each independently represents an integer of 1 or more. The upper limit of p3 is not particularly limited. In many cases, p3 is an integer of 25 or less. Particularly, in view of further improving the effects of the present invention, p3 is preferably an integer of 2 to 20, more preferably an integer of 4 to 10, even more preferably an integer of 4 to 8, and particularly preferably 8.

The content of the repeating unit represented by Formula (3) is not particularly limited. In view of further improving the effects of the present invention, the content of the repeating unit represented by Formula (3) with respect to the total content of repeating units in the polymer is preferably 5 to 30 mol %, and more preferably 10 to 20 mol %.

The weight-average molecular weight of the polymer according to the embodiment of the present invention is not particularly limited. In view of further improving the effects of the present invention, the weight-average molecular weight of the polymer is preferably 1,000 to 300,000, and more preferably 5,000 to 250,000.

The weight-average molecular weight is measured by Gel Permeation Chromatography (GPC). For example, HLC-8220GPC (manufactured by Tosoh Corporation) is used as a GPC system, three columns consisting of TSKgeL Super HZ2000, TSKgeL Super HZ4000, and TSKgeL Super HZ-H (all of these are manufactured by Tosoh Corporation, 4.6 mm×15 cm) are connected in series, and tetrahydrofuran (THF) is used as an eluent. The sample concentration is 0.3% by mass, the flow rate is 0.35 ml/min, the sample injection amount is 10 μL, the measurement temperature is 40° C., and an IR (infrared) detector is used as a detector. The calibration curve is prepared from 6 samples of “Standard sample TSK standard, polystyrene” manufactured by Tosoh Corporation: “F-80”, “F-20”, “F-4”, “F-2”, “A-5000”, and “A-1000”.

(Synthesis Method)

The synthesis method of the polymer according to the embodiment of the present invention is not particularly limited. Known methods can be appropriately adopted as the synthesis method.

Particularly, in view of excellent productivity, the polymer may be synthesized, for example, by a method of causing a polycondensation reaction between glycerol and a divalent carboxylic acid compound represented by Formula (Y) so as to obtain a polymer, and then reacting hydroxyl groups in the obtained polymer with an isocyanate compound represented by Formula (Z).

Hereinafter, the above method will be specifically described.

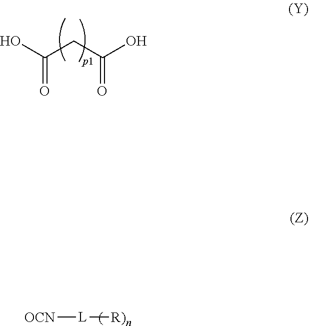

p1 in Formula (Y) has the same definition as p1 in Formula (1).

For example, (Y) is a glutaric acid in a case where p1 is 3, adipic acid in a case where p1 is 4, pimelic acid in a case where p1 is 5, azelaic acid in a case where p1 is 7, and sebacic acid in a case where p1 is 8.

L and n in Formula (Z) have the same definitions as L and n in Formula (1).

Examples of the isocyanate compound represented by Formula (Z) include compounds obtained by reacting a known diisocyanate with a known hydroxyacrylate (for example, 2-hydroxyethyl acrylate, 2-hydroxypropyl acrylate, 4-hydroxybutyl acrylate, 4-hydroxybutyl diacrylate, 1,4-cyclohexanedimethanol monoacrylate, 2-hydroxy-3-phenoxypropyl acrylate, or pentaerythritol triacrylate).

More specifically, examples thereof include 2-methacryloyloxyethyl isocyanate, an adduct of 5-isocyanato-1-(isocyanatomethyl)-1,3,3-trimethylcyclohexane and 2-hydroxyethyl acrylate, 2-(5-isocyanato-1,3,3-trimethylcyclohexylmethylcarbamoyloxy)-ethyl acrylate, 2-(3-isocyanatomethyl-3,5,5-trimethyl-cyclohexylcarbamoyloxy)-ethylacrylate, 2-(4′-isocyanato-4-diphenylmethanecarbamoyloxy)-ethyl acrylate, 2-(5-isocyanato-1-carbamoyloxy)-ethyl acrylate, 4-(5-isocyanato-1,3,3-trimethyl-cyclohexylmethylcarbamoyloxy)-butyl acrylate, 4-(3-isocyanatomethyl-3,5,5-trimethyl-cyclohexylcarbamoyloxy)-butyl acrylate, 4-(4′-isocyanato-4-diphenylmethanecarbamoyloxy)-butyl acrylate, and 4-(5-isocyanato-1-carbamoyloxy)-butyl acrylate.

The method of polycondensation reaction between glycerol and the divalent carboxylic acid compound represented by Formula (Y) is not particularly limited. As the method, a heat treatment is preferable. The heating temperature during the heat treatment is preferably 100° C. to 190° C., and more preferably 120° C. to 160° C. The heating time is preferably 10 to 48 hours, and more preferably 20 to 40 hours.

There is no particular limit on the molar ratio between glycerol and the divalent carboxylic acid compound represented by Formula (Y) that are mixed together. The ratio of a molar amount of the used divalent carboxylic acid compound represented by Formula (Y) to a molar amount of the used glycerol (molar amount of used divalent carboxylic acid compound represented by Formula (Y)/molar amount of used glycerol) is preferably 0.5 to 1.5, and more preferably 0.8 to 1.2.

After glycerol is reacted with the divalent carboxylic acid compound represented by Formula (Y), if necessary, a purification treatment such as a reprecipitation treatment may be carried out.

Among three hydroxyl groups in the glycerol, two are bonded to primary carbon atoms, and one is bonded to a secondary carbon atom. Among the three hydroxyl groups, the hydroxyl group bonded to the secondary carbon atom has lower reactivity compared to the hydroxyl groups bonded to the primary carbon atoms. Therefore, an unreacted hydroxyl group is likely to remain in the polymer obtained by the polycondensation reaction (hereinafter, also simply called “precursor polymer”).

The reaction conditions may be controlled so that the amount of the residual unreacted hydroxyl groups is adjusted.

Next, the hydroxyl group in the precursor polymer is reacted with the isocyanate compound represented by Formula (Z) so that a predetermined polymerizable group is introduced into the precursor polymer via a urethane bond.

The method for reacting the precursor polymer with the isocyanate compound represented by Formula (Z) is not particularly limited. For example, a method of mixing together the precursor polymer and the isocyanate compound may be used. If necessary, a heat treatment may be performed during mixing. The heating temperature during the heat treatment is preferably 10° C. to 100° C., and more preferably 20° C. to 80° C.

The mixing time is preferably 0.5 to 8 hours, and more preferably 2 to 6 hours.

After the reaction ends, if necessary, a purification treatment such as a reprecipitation treatment may be carried out.

The reaction described above may be performed in the presence of a solvent. Examples of the solvent include water and an organic solvent. Examples of the organic solvent include an amide (example: N,N-dimethylformamide), a sulfoxide (example: dimethyl sulfoxide), a heterocyclic compound (example: pyridine), a hydrocarbon (example: benzene or hexane), an alkyl halide (example: chloroform or dichloromethane), an ester (example: methyl acetate, ethyl acetate, or butyl acetate), a ketone (example: acetone or methyl ethyl ketone), and an ether (example: tetrahydrofuran or 1,2-dimethoxyethane). Two or more kinds of organic solvents may be used in combination.

The synthesis method of the polymer according to the embodiment of the present invention is not limited to the above method. Examples thereof include a method of performing a polycondensation reaction of glycerol and the divalent carboxylic acid compound represented by Formula (Y) so as to obtain a polymer, then reacting hydroxyl groups in the obtained polymer with a diisocyanate compound so as to synthesize a polymer having an isocyanate group, and reacting the obtained polymer with a compound having a predetermined polymerizable group (an acryloyloxy group, a methacryloyloxy group, an acrylamide group, or a methacrylamide group) and a group capable of reacting with an isocyanate group (for example, a hydroxyl group).

(Use)

The polymer according to the embodiment of the present invention can be suitably used as a material of a curable composition as will be described later.

<Curable Composition Ad Cured Substance>

The curable composition according to an embodiment of the present invention contains the polymer described above.

The content of the polymer in the curable composition is not particularly limited.

The content of the polymer with respect to the total solid content in the curable composition is preferably 5% to 100% by mass, and more preferably 10% to 95% by mass.

The solid content is components that can constitute a cured film and do not include a solvent. Even though the components are a liquid, they are regarded as a solid content in calculating the above total solid content.

The curable composition may contain components other than the polymer.

For example, the curable composition may contain a polymerization initiator. The polymerization initiator is selected depending on the mode of polymerization reaction. Examples thereof include a thermal polymerization initiator and a photopolymerization initiator.

In the curable composition, the content of the polymerization initiator with respect to the total solid content of the curable composition is preferably 0.01% to 20% by mass, and more preferably 0.5% to 10% by mass.

The curable composition may contain a solvent.

Examples of the solvent include the solvent used during the reaction of the polymer described above.

In the curable composition, the content of a solvent with respect to the total mass of the curable composition is preferably 1% to 50% by mass, and more preferably 5% to 30% by mass.

The curable composition may contain a surfactant in addition to the above components.

The curable composition is capable of forming a cured substance showing excellent adhesiveness with respect to a wet adherend. Therefore, the curable composition is suitably used as a medical adhesive.

Examples of the method of using the curable composition include a method of applying the curable composition to a predetermined position of an adherend so as to form a coating film and performing a curing treatment on the coating film so as to obtain a cured substance.

Examples of the curing treatment include a light irradiation treatment and a heat treatment. Particularly, in view of manufacturing suitability, the light irradiation treatment is preferable, and an ultraviolet irradiation treatment is more preferable.

The irradiation conditions of the light irradiation treatment are not particularly limited, but an irradiation dose of 50 to 2,000 mJ/cm² is preferable.

### EXAMPLES

Hereinafter, the features of the present invention will be more specifically described based on examples and comparative examples. The materials, the amounts and ratios of the materials used, the details of treatments, the procedures of treatments, and the like shown in the following examples can be appropriately changed as long as the gist of the present invention is maintained. Therefore, the scope of the present invention is not limited to the following specific examples.

### Example 1

Under a nitrogen stream (200 mL/min), glycerol (46.0 g, 0.50 mol) and sebacic acid (101.1 g, 0.50 mol) were mixed together in a separable flask at 140° C. for 27 hours (stirring rate: 100 rpm), thereby obtaining 121.1 g of polyglycerol sebacate (PGS) having a mass average molecular weight of 25,000 (yield: 88%).

The obtained PGS (2.5 g, 9.7 mmol) was dissolved in tetrahydrofuran (25 mL), thereby preparing a solution. While the obtained solution was being stirred with a magnetic stirrer, a solution prepared by dissolving 2-isocyanatoethyl acrylate (1.37 g, 9.7 mmol) in tetrahydrofuran (5 mL) was added dropwise to the solution at 25° C. in the atmosphere for 3 minutes. The obtained reaction solution was stirred at 25° C. for 1 hour and 30 minutes, and then further stirred at 50° C. for 2 hours. The obtained reaction solution was filtered through filter paper, thereby obtaining a filtrate (26.5 g). t-Butyl methyl ether (130 g) was added to the obtained filtrate, followed by reprecipitation, thereby obtaining 1.2 g of a polymer 1 (see the following scheme).

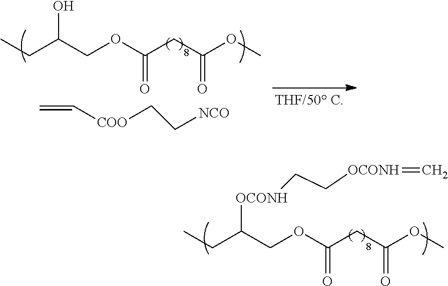

The structure of the obtained polymer 1 was analyzed by ¹H NMR (deuterated chloroform solution).

δ1.1 (811), δ1.3 (4H), δ2.2 (4H), δ3.3 (2H), δ3.8-4.1 (41H), δ4.2 (2H), δ5.1 (11H), δ5.9 (1H), δ6.2 (11H), δ6.4 (1H).

The obtained polymer 1 contained a repeating unit (p1=8) represented by Formula (1), and the content of the repeating unit represented by Formula (1) is 48 mol % with respect to the total content of repeating units in the polymer 1.

Furthermore, the obtained polymer 1 contained a repeating unit (p2=8) represented by Formula (2), and the content of the repeating unit represented by Formula (2) is 25 mol % with respect to the total content of repeating units in the polymer 1.

In addition, the obtained polymer 1 contained a repeating unit (p3=8) represented by Formula (3), and the content of the repeating unit represented by Formula (3) is 12 mol % with respect to the total content of repeating units in the polymer 1.

Next, the obtained polymer 1 (1 g), ethanol (0.1 g), and a photoradical polymerization initiator (IRGACURE 819) (0.01 g) were mixed together, thereby preparing a curable composition 1.

### Example 2

A polymer 2 and a curable composition 2 were prepared according to the same procedure as in Example 1, except that 1,1-(bisacryloyloxymethyl)ethyl isocyanate (see the following structural formula) was used instead of 2-isocyanatoethyl acrylate.

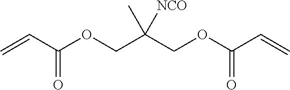

### Example 3

A polymer 3 and a curable composition 3 were prepared according to the same procedure as in Example 1, except that 2-isocyanatoethyl methacrylate (see the following structural formula) was used instead of 2-isocyanatoethyl acrylate.

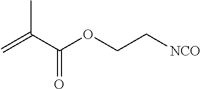

### Example 4

A polymer 4 and a curable composition 4 were prepared according to the same procedure as in Example 1, except that 2-(2-methacryloyloxyethyloxy)ethyl isocyanate (see the following structural formula) was used instead of 2-isocyanatoethyl acrylate.

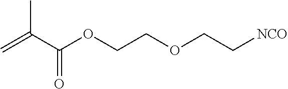

### Comparative Example 1

PGS (2.5 g, 9.7 mmol) manufactured in Example 1, triethylamine (0.98 g, 9.7 mmol), N,N-dimethyl-4-aminopyridine (0.003 g), and 4-methoxyphenol (0.013 g) were dissolved in tetrahydrofuran (40 mL), thereby preparing a solution. While the obtained solution was being stirred with a magnetic stirrer, a solution prepared by dissolving acrylic acid chloride (0.88 g, 9.7 mmol) in tetrahydrofuran (3 mL) was added dropwise to the solution under ice cooling (0° C.) for 20 minutes. Then, the obtained reaction solution was stirred at 0° C. for 1 hour. The obtained reaction solution was filtered through filter paper, and the obtained filtrate was added dropwise to water (400 mL), followed by reprecipitation, thereby obtaining 2.2 g of a polymer C1.

The obtained polymer C1 has a polymerizable group introduced into the polymer via an ester group and does not have a urethane bond.

Next, the obtained polymer C1 (1 g), ethanol (0.1 g), and a photoradical polymerization initiator (IRGACURE 819) (0.01 g) were mixed together, thereby preparing a curable composition C1.

### Comparative Example 2

A polymer C2 and a curable composition C2 were prepared according to the same procedure as in Example 1, except that allyl isocyanate (see the following structural formula) was used instead of 2-isocyanatoethyl acrylate.

The obtained polymer C2 did not contain a predetermined polymerizable group.

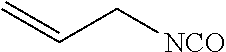

<Evaluation: Wet Adhesiveness>

A collagen sheet (Chondro-Gide manufactured by Geistlich Pharma AG) cut in 1 cm×5 cm was immersed in physiological saline for 24 hours. Then, the collagen sheet was taken out, and the surface thereof was wiped off with physiological saline. Thereafter, the collagen sheet was spread on a glass plate, and a 1 cm×1 cm portion at the edge of the collagen sheet was covered with Cellophane tape (registered trademark).

The entire collagen sheet including the portion of Cellophane tape (registered trademark) was coated with the curable composition 1 (about 1 g) by using a silicone resin spatula. The obtained coating film was cured by being irradiated with ultraviolet rays, thereby obtaining a cured film. Then, from a peel start point, which was the position of the Cellophane tape (registered trademark) on the collagen sheet, the cured film was pulled by a tensile tester at a tensile speed of 1 mm/sec, and the load was measured. In this way, wet adhesion between the cured film and the collagen sheet was measured, and evaluated according to the following standard. The grade “A” or “B” is a passing grade of this test.

A: The cured film was not peeled off, or the wet adhesion was 3 N/cm or more.

B: Wet adhesion was 1 N/cm or more and less than 3 N/cm.

C: Wet adhesion was less than 1 N/cm.

TABLE 1

| | Wet adhesion |
|---|---|
| Example 1 | A |
| Example 2 | A |
| Example 3 | B |
| Example 4 | B |
| Comparative Example 1 | C |
| Comparative Example 2 | C |

As shown in the above table, it has been confirmed that the polymer according to the embodiment of the present invention brings about desired effects.

Particularly, by the comparison of Examples 1 to 4, it has been confirmed that the effects are further improved in a case where the polymerizable group is an acryloyloxy group.

What is claimed is:

1. A polymer comprising:
a repeating unit represented by Formula (1), 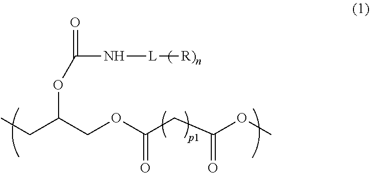
R represents an acryloyloxy group, a methacryloyloxy group, an acrylamide group, or a methacrylamide group,
L represents an (n+1)-valent linking group,
m represents an integer of 1 or more, and
m represents an integer of 1 or more.

2. The polymer according to claim 1,
wherein R represents an acryloyloxy group.

3. The polymer according to claim 1,
wherein n is 1 or 2.

4. The polymer according to claim 1,
wherein p1 is an integer of 4 to 10.

5. A curable composition comprising:
the polymer according to claim 1.

6. The curable composition according to claim 5, further comprising:
a polymerization initiator.

7. A cured substance formed of the curable composition according to claim 5.

8. The polymer according to claim 2,
wherein n is 1 or 2.

9. The polymer according to claim 2,
wherein p1 is an integer of 4 to 10.

10. A curable composition comprising:
the polymer according to claim 2.

11. The curable composition according to claim 10, further comprising:
a polymerization initiator.

12. A cured substance formed of the curable composition according to claim 6.

13. A cured substance formed of the curable composition according to claim 10.

14. A cured substance formed of the curable composition according to claim 11.

15. The polymer according to claim 3,
wherein p1 is an integer of 4 to 10.

16. A curable composition comprising:
the polymer according to claim 3.

17. The curable composition according to claim 16, further comprising:
a polymerization initiator.

18. A cured substance formed of the curable composition according to claim 16.

19. A cured substance formed of the curable composition according to claim 17.

20. A curable composition comprising:
the polymer according to claim 4.
